(19) United States
(12) Patent Application Publication
(10) Pub. No.: US 2026/0216750 A1
(43) Pub. Date: Jul. 30, 2026

(54) SOLIDS SEPARATION SCREEN WITH PATTERNED ENCAPSULATION

(71) Applicant: SCHLUMBERGER TECHNOLOGY CORPORATION, Sugar Land, TX (US)

(72) Inventors: Claire Rosaleen MCLEAN, Edinburgh (GB); Eric CADY, Florence, KY (US); Lavanya RAGHAVENDRAN, Thane (IN)

(21) Appl. No.: 19/143,392

(22) PCT Filed: Feb. 23, 2024
(86) PCT No.: PCT/US2024/017053

§ 371 Date: Jun. 26, 2025

Related U.S. Application Data
(60) Provisional application No. 63/486,774, filed on Feb. 24, 2023.

(51) Int. Cl. B07B 1/46; B07B 1/04

(52) U.S. Cl. CPC B07B 1/4663; B07B 1/04; B07B 1/4672

(57) ABSTRACT

Solids separation screens are described herein that have a primary separation layer comprising a wire mesh and a patterned fusible encapsulant structure encapsulating a portion of the wire mesh in a pattern.

### CROSS-REFERENCE TO RELATED APPLICATIONS

This patent application claims benefit of U.S. Provisional Patent Application Ser. No. 63/486,774 filed Feb. 24, 2023, which is entirely incorporated herein by reference.

### FIELD

This patent application relates to apparatus and methods for separating coarse solids from liquids. Specifically, methods and apparatus are described herein for providing structural support for solids separation screens that also improves functionality of the screens.

### BACKGROUND

Solids separation is a fundamentally important part of subterranean resource recovery. Solids are commonly produced along with whatever resource is being intentionally recovered, and the solids must be separated for many reasons. In a hydrocarbon production facility, for example, materials flow out of a well and must be separated into valuable resource materials and other materials. The other materials may be by-products, or may be environmental or other waste materials, some of which can be treated and returned to the environment under appropriate conditions.

When a hydrocarbon well is being drilled into the earth, drilling fluids are commonly used to simplify the drilling process. Such fluids are complex compositions having specific components in specific quantities to achieve specific results. The fluids are, therefore, valuable and are typically recycled and re-used, rather than being discarded upon a single use. In order to recycle and re-use the fluids, solids resulting from the drilling activity must be removed from the fluids. To separate the solids, commonly called “drill cuttings,” separation facilities are commonly used.

Solids separation facilities used in hydrocarbon production facilities to separated drill cuttings commonly use screens. FIG. 1 is an exploded view of a conventional solids separation screen 10. The separation screen 10 has a frame 11 that generally provides structural strength for the screen 10. The frame 11 is typically made of a structurally strong material such as metal or plastic, which can be molded or cast into a convenient shape. This frame 11 has an internal support structure that is overmolded with plastic. Usually the frame has a rectilinear shape defined by a plurality of boundary members. The frame may also have intermediate members between the boundary members.

The separation screen 10 has three layers of wire mesh structures attached to the frame. A first wire mesh structure 12 of the screen 10 has a first mesh size. A second wire mesh structure 13 of the screen 10 has a second mesh size. A third wire mesh structure 14 of the screen 10 has a third mesh size. Each of the first, second, and third wire mesh structures 12, 13, and 14 are attached to the frame 11 in a convenient way. The wire mesh structures 12, 13, and 14 may be attached to the frame 11 by use of fasteners, by mechanical capture between the frame 11 and a capture member (not shown), by chemical or thermal adhesion, or a combination thereof. Typically, the third mesh size is larger than the first mesh size and the second mesh size, which may be the same or different. Where the first and second mesh sizes are differently, the second mesh size is typically larger than the first mesh size so that any solids penetrating the first wire mesh structure pass through the screen 10.

Fluids and fine solids flow through the screen 10 and larger solids (the drill cuttings) are captured by the screen 10. Often, to improve separation, the screen 10 is shaken or vibrated. The vibration and abrasion of rock on the screen materials causes extreme wear on the screens. Additionally, throughput is always of paramount concern with any capital equipment in a hydrocarbon production facility. Thus, durable solids separation screens that have long useful life with minimal downtime for replacement or repair, and that also promote efficient throughput, are always desired.

### SUMMARY

Embodiments described herein provide a solids separation screen comprising a primary separation layer comprising a wire mesh structure and a patterned encapsulant structure encapsulating a portion of the wire mesh in a pattern, the encapsulant structure comprising a polymer material encapsulating portions of the wire mesh. These solids separation screens can be used in the context of hydrocarbon production or in any other application where solids and liquids are separated using separation screens.

Other embodiments described herein provide a method of making a solids separation screen, comprising obtaining a first wire mesh structure having a first mesh size, a second wire mesh structure having a second mesh size, and a third wire mesh structure having a third mesh size, the third mesh size larger than the first mesh size and the second mesh size; disposing a patterned fusible structure having a linear, angled, or curved pattern, or combination of such patterns, against the first and second wire mesh structures; applying heat and pressure to the first wire mesh structure, the second wire mesh structure, and the patterned fusible material to heat the first wire mesh structure, the second wire mesh structure, and the patterned fusible material to a first temperature below a second temperature at which the first wire mesh structure and the second wire mesh structure are affected; encapsulating at least a portion of the first wire mesh structure and the second wire mesh structure with the patterned fusible material to form a supported wire mesh structure; and attaching the supported wire mesh structure and the third wire mesh structure to a frame.

Other embodiments described herein provide a solids separation screen, comprising a frame; a primary separation layer attached to the frame, the primary separation layer comprising a first metal wire mesh structure; a second metal wire mesh structure; and a patterned fusible structure encapsulating a portion of the first wire mesh structure, the second wire mesh structure, or both; and a third metal wire mesh structure attached to the frame.

### BRIEF DESCRIPTION OF THE DRAWINGS

FIG. 1 is an exploded view of a prior art solids separation screen.

FIG. 2A is a side detail view of a portion of a solids separation screen according to one embodiment.

FIG. 2B is a top plan view of a portion of the solids separation screen of FIG. 2A.

FIGS. 3A-3C are exploded views of different configurations of solids separation screens having the pattern of FIG. 2B.

FIGS. 4-12B are plan views of different embodiments of solids separation screens.

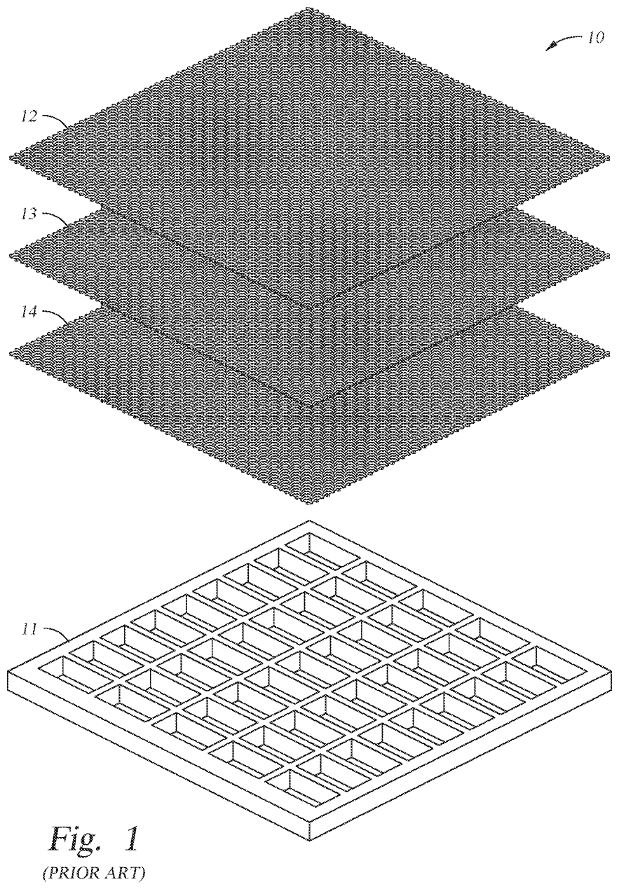

### DETAILED DESCRIPTION

Apparatus and methods are described herein for efficient and effective solids separation in a hydrocarbon production facility. Screens for separating coarse solids, such as drill cuttings, from a fluid, such as a drilling fluid, are described herein. The screens have multiple layers, and a primary separation layer of the screens, which is the layer in direct contact with materials to be separated, and which is not between any two other layers of the screen, has a patterned encapsulant structure.

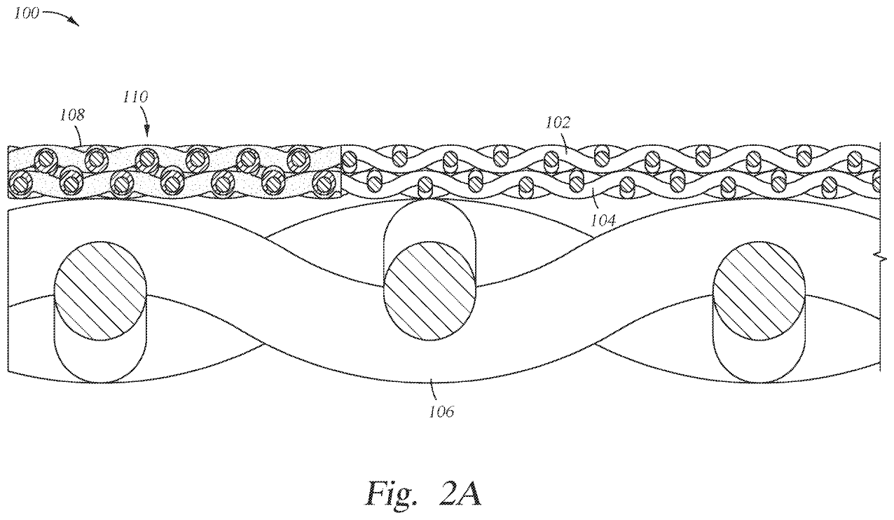

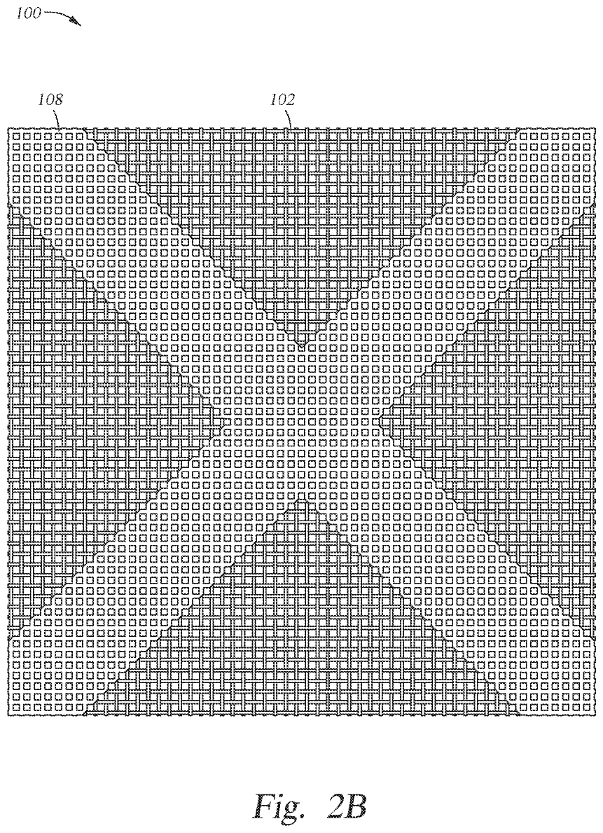

FIG. 2A is a side detail view of a portion of a solids separation screen 100 according to one embodiment. The solids separation screen 100 has a first wire mesh structure 102, a second wire mesh structure 104, and a third wire mesh structure 106. The first wire mesh structure 102 has a first mesh size, the second wire mesh structure 104 has a second mesh size, and the third wire mesh structure 106 has a third mesh size. Here, the third wire mesh size is larger than the first wire mesh size and the second wire mesh size.

A portion of the first wire mesh structure 102 and the second wire mesh structure 104 is encapsulated in a patterned fusible structure 108 that softens at a first temperature that is less than a second temperature at which the first wire mesh structure 102, the second wire mesh structure 104, or the third wire mesh structure 106 are affected. Here, the first wire mesh structure 102, the second wire mesh structure 104, and the patterned fusible structure 108 define a primary separation layer 110 of the solids separation screen 100. The primary separation layer provides the primary surface that comes into contact with material to be separated. As noted above, the material typically contains liquids and solids of various size. The primary separation layer 110 allows liquids and solids smaller than the smallest mesh size of the solids separation screen 100 to pass and blocks larger solids. In this case, the primary separation layer 110 is not fused to the third wire mesh structure 106 to allow the primary separation layer 110 and the third wire mesh structure 106 to move and flex independently. Among other advantages, the patterned fusible material encapsulating portions of the first and second wire mesh structures 102 and 104 provides a cushion for the primary separation layer 110 against collision with the third wire mesh structure 106, reducing wear on both structures.

Here, each of the wire mesh structures 102, 104, and 106 are woven wire structures made of a metal material, such as stainless steel. In other embodiments, the wire mesh structures 102, 104, and 106 could be made of other strong materials, such as strong polymer materials. The patterned fusible structure encapsulates portions of the wire mesh structures 102 and 104 to provide increased strength at the encapsulated regions and to join the first and second wire mesh structures 102 and 104 as the primary separation layer 110.

The material of the patterned fusible structure 108 is patterned in that some parts of the wire mesh structures 102 and 104 are not encapsulated while other parts are encapsulated. FIG. 2B is a top plan view of a portion of the solids separation screen 100. This view shows portions of the wire mesh structures that are encapsulated and portions that are not encapsulated. The patterned fusible material, in this case, comprises a plurality of linear segments, such as stripes, ribs, or lines that cross each other at 90 degree angles leaving open areas not encapsulated by fusible material. The patterned fusible material, in this case, is linear and angled.

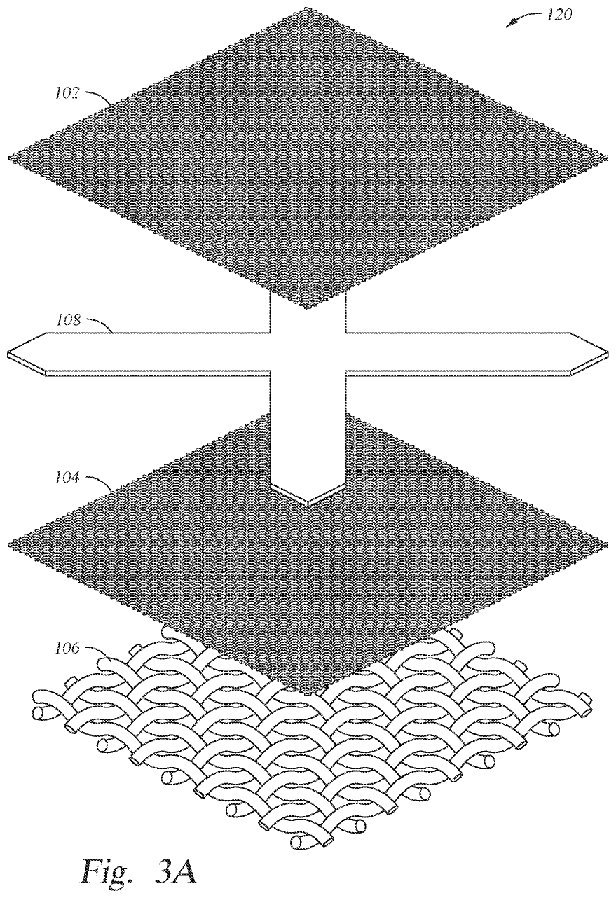

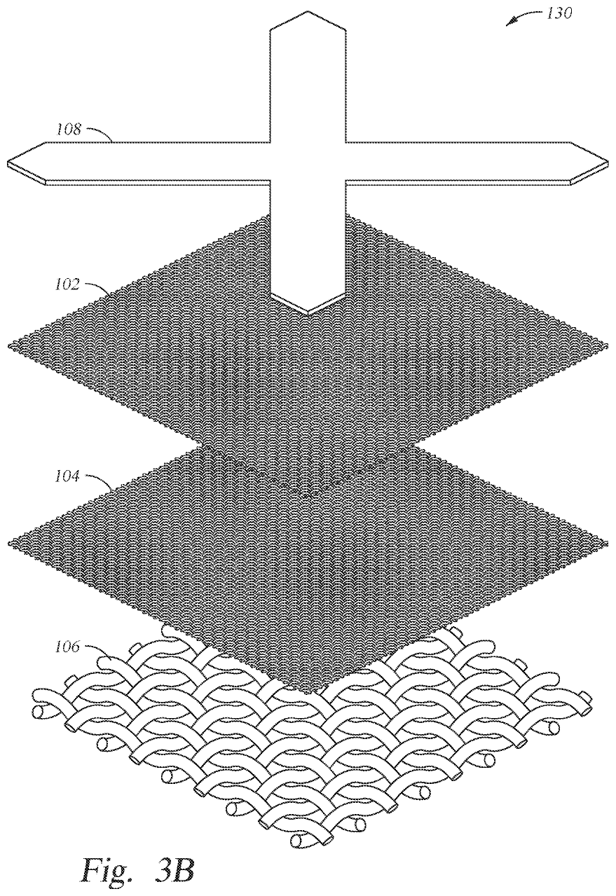

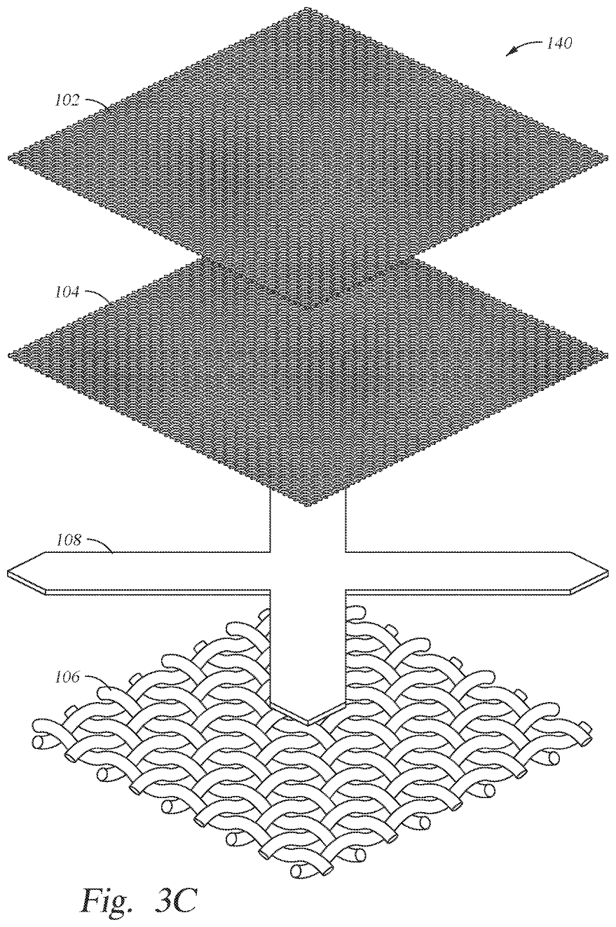

The patterned fusible structure 108 is disposed against the first and second wire mesh structures 102 and 104, and the three elements are fused together by application of heat and pressure. FIGS. 3A-3C are exploded views of different configurations of solids separation screens having the pattern of FIG. 2B. In the embodiment of FIG. 3A, the patterned fusible structure 108 is disposed between the first and second wire mesh structures 102 and 104 and against both wire mesh structures. A temperature of the three components is increased to a temperature at which the patterned fusible structure 108 softens, and pressure is applied to the three components to fuse them together to make a primary separation layer. FIG. 3B is an embodiment wherein the first wire mesh structure 102 and the second wire mesh structure 104 are between the patterned fusible structure 108 and the third wire mesh structure 106. In FIG. 3C, the patterned fusible structure 108 is between the first and second wire mesh structures 102 and 104 and the third wire mesh structure 106. In embodiments like FIGS. 3A and 3B where the patterned fusible structure 108 is not in contact with the third wire mesh structure 106, the entire mesh portion of the screen, comprising the first wire mesh structure 102, the second wire mesh structure 104, the third wire mesh structure 106, and the patterned fusible structure 108 can be subjected to heat and pressure to fuse the structures that are in contact with the patterned fusible structure 108 by flowing the material of the patterned fusible structure 108 around portions of the first and second wire mesh structures 102 and 104 to encapsulate portions thereof. In embodiments like FIG. 3C where the patterned fusible structure 108 may contact components not intended for encapsulation or fusing, the first and second wire mesh structures 102 and 104 and the patterned fusible structure 108 can be subjected to heat and pressure treatment to encapsulate portions of the first and second wire mesh structures 102 and 104 and form the primary separation layer 110 before bringing the primary separation layer 110 into contact with the third wire mesh structure 106, to avoid fusing the third wire mesh structure 106 to the primary separation layer 110. Additionally, in embodiments like FIG. 3C, where the patterned fusible structure 108 separates the first and second wire mesh structures 102 and 104 from the third wire mesh structure 106, the first and second wire mesh structures 102 and 104 can be easily separated from the third wire mesh structure 106 in the event the screen is disassembled, for example if the wire mesh structures are to be cleaned. The patterned fusible structure 108 can function as a separation layer to facilitate disassembly and separation of the wire mesh structures of the screen.

The fusible material is generally a polymeric thermoplastic or elastomeric material that softens at a first temperature that is less than a second temperature at which the wire mesh structures 102, 104, and 106 are affected, whether the wire mesh structures are made of metal or are themselves made of a polymeric material. The materials used are generally materials that are substantially compatible with exposure to hydrocarbon. Examples of materials that can be used include polypropylene, polycarbonate, polyethylene, nylon, and other tough resins. Polyurethane precursor can also be applied as a fusible material so long as the wire mesh structures are coated with the precursor before the precursor polymerizes into set polyurethane. Other A/B polymers, such as epoxy, can also be used in this way. Where polymers prone to crystallization, such as polyethylene, are used, the polymer is applied under conditions unlikely to increase brittleness, for example by refraining from temperatures that can fully melt the polymer. Adhesive polymers, such as urethane and epoxy, can be applied as dots or lines of thick liquid onto the first wire mesh structure, and the second wire mesh structure can then be pressed onto the first wire mesh structure with the liquid lines, such that the liquid encapsulates portions of the first and second wire mesh structures before setting.

The fusible material is generally thin in the thickness direction of the solids separation screen, for example from about 0.3 to 1.5 mm. In one case, the patterned fusible material has a thickness of about 0.5 mm. The patterned fusible material can be applied in sheets, strips, cords, polygonal sections, and the like. In one case, a patterned fusible material can be a single sheet-like body having areal extent matching the areal extent of the wire mesh structures, such that the patterned fusible material is applied as a single sheet extending from end-to-end and side-to-side of the screen. In other cases, sections of patterned fusible material can be applied, such as quarter-screen sections or half-screen sections. In other cases, strips can be disposed against the wire mesh structures in a crossing pattern, so when the material softens under pressure, all the strips combine and encapsulate the portions of the wire mesh structures.

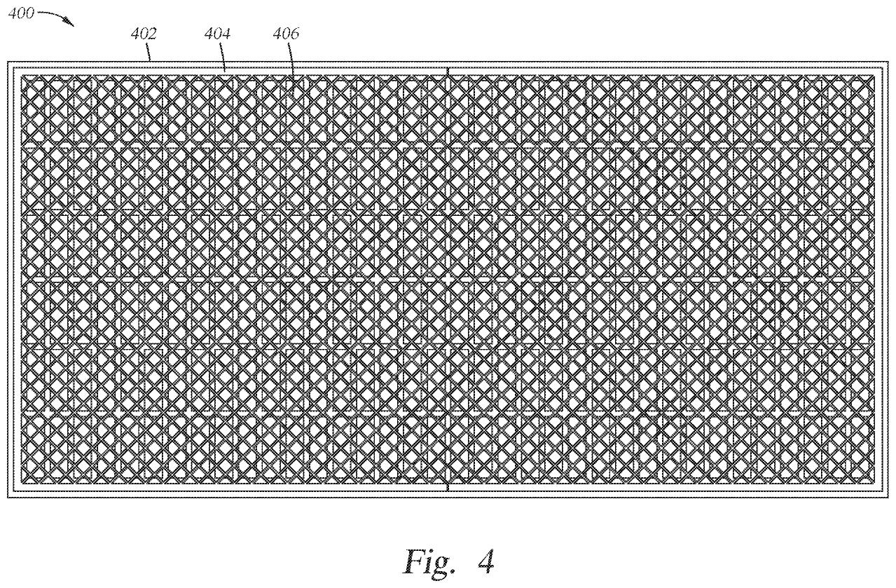

FIG. 4 is a plan view of a solids separation screen 400 according to one embodiment. The solids separation screen 400 generally has a linear, angled pattern of fusible material, similar to the pattern of FIG. 2B, repeated across the entire areal extent of the screen 400. Thus, in this case, a plurality of stripes, ribs, or lines of fusible material intersect at 90 degree angles to create a patterned fusible material with a rectilinear structure. The linear elements of the fusible material can be implemented as stripes generally wider than they are thick, as ribs generally thicker than they are wide, or lines having similar, but small, width and thickness. The screen 400 has a frame 402 that defines a first rectilinear structure and a screen 404, attached to the frame 402, the screen 404 having a patterned fusible material 406 that defines a second rectilinear structure. Here, the second rectilinear structure is oriented at an angle to the first rectilinear structure. The angle can be any convenient angle, but in this case is 45 degrees, making the pattern of the patterned fusible material “oblique” relative to the frame and the wire mesh structures. An “oblique” pattern, or in general any pattern not specifically aligned with the rectilinear pattern of the frame and/or the wire mesh structures, can be used to influence movement of materials across the screen. In this case, the 45 degree pattern encourages movement of solids in a first direction of the first rectilinear structure and discourages movement of solids in a second direction of the first rectilinear structure orthogonal to the first direction, the first and second directions being dependent on the mode of use of the screen 400.

The pattern of the patterned fusible material of the screen 400 is a regular, periodic pattern of parallel stripes, ribs, or lines all having the same width, thickness, spacing, and angle of intersection. The pattern of the patterned fusible material can vary, and any convenient pattern can be used. The pattern may be regular or irregular. The pattern may also, independently, be periodic or non-periodic. Here, a “regular” pattern is a pattern that has repetition, periodicity, and/or symmetry, and an “irregular” pattern is any pattern that is not “regular.” As noted above, the pattern can have linear, angled, and curved aspects, and can combine any or all such aspects. For example, a patterned fusible material can have linear portions and curved portions, and may also have angled portions. In other cases, the pattern might have only linear portions or only curved portions.

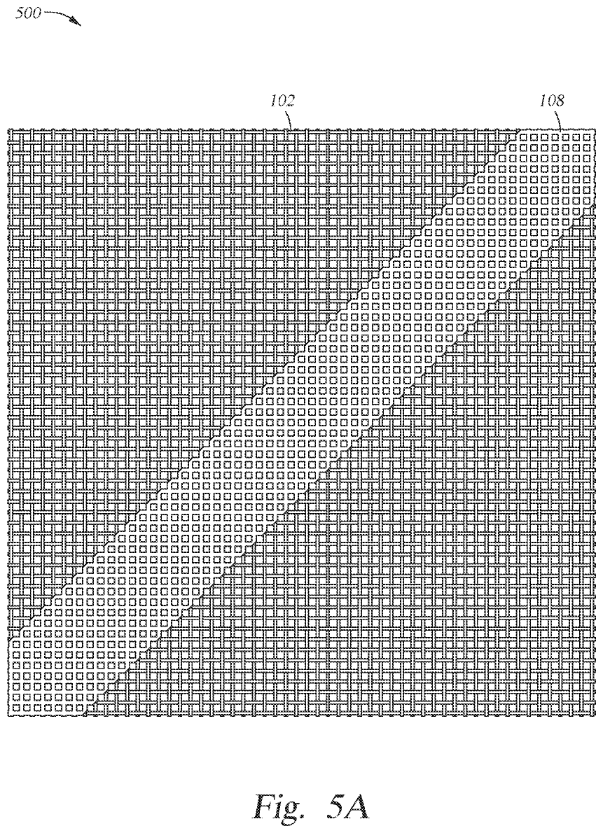

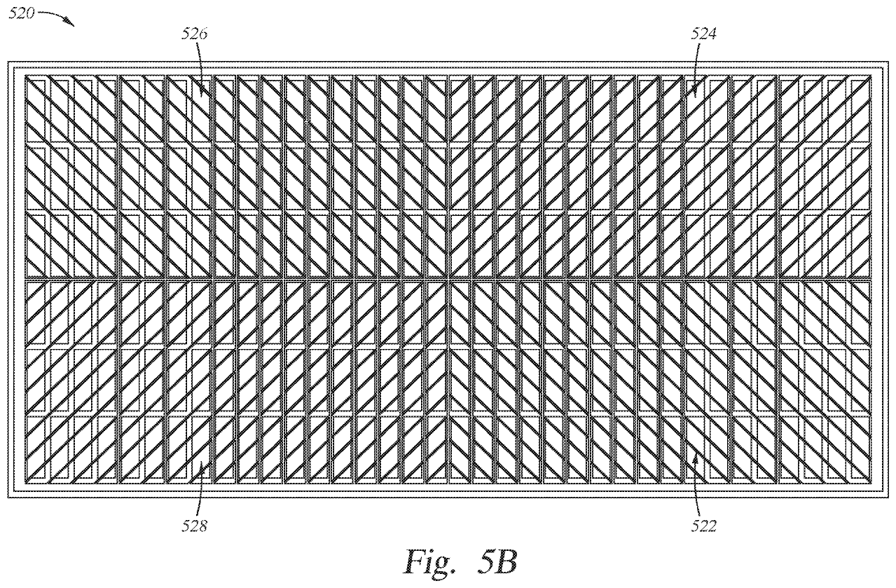

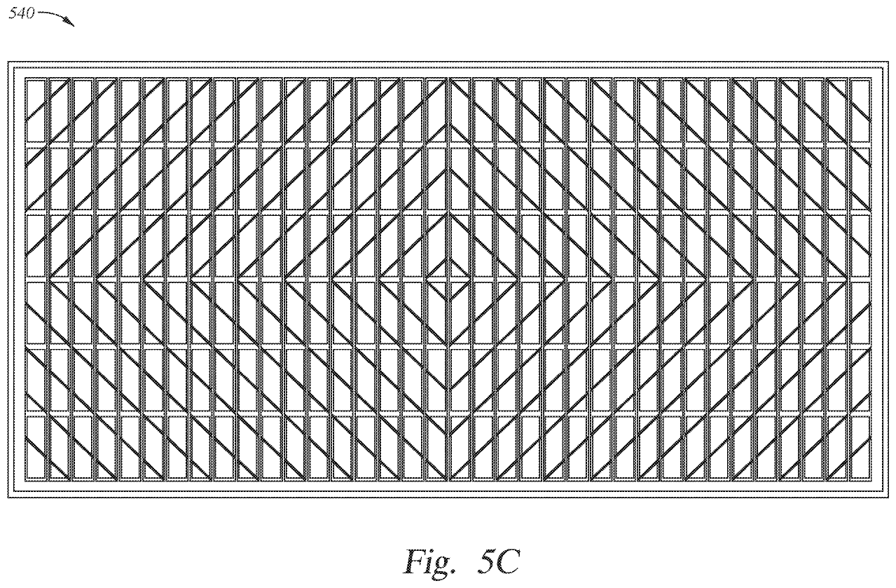

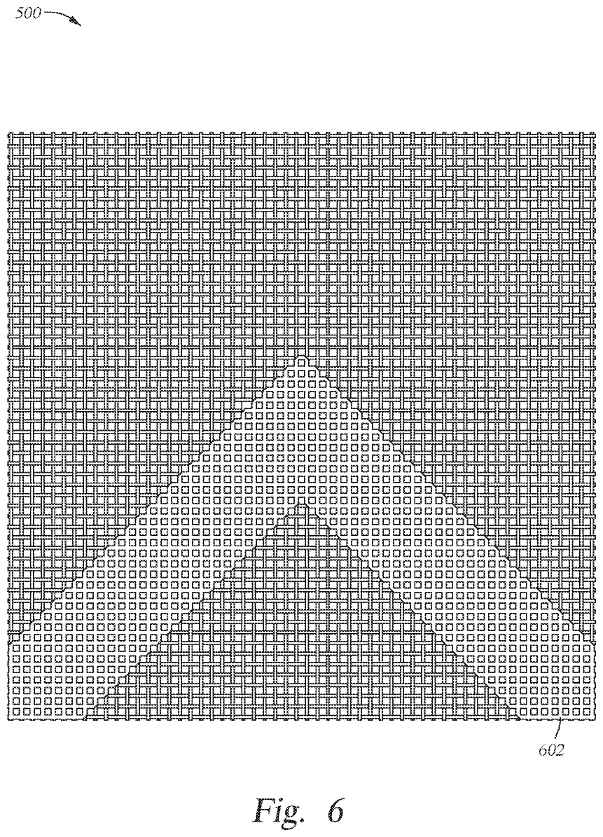

FIG. 5A is a plan view of a portion of a solids separation screen 500, according to another embodiment. Here, a stripe of fusible material is used, and can be used in a periodic pattern to create a regular, periodic, oblique patterned fusible structure in the solids separation screen 500. FIG. 5B is a plan view of a solids separation screen 520 that uses the pattern of the screen 500 of FIG. 5A. The screen 520 has different sections of the patterned fusible material rotated in orientation to create an overall pattern for the screen 520 that is linear and angled. The pattern of the screen 520 has straight, parallel, oblique linear elements 522, which can be stripes, ribs, or lines of fusible material extending across the areal extent of one-quarter of the screen 520. Each quarter of the screen 520 has such a pattern of straight, parallel, oblique linear elements. Opposite quarters of the screen 520 use the patterned fusible material in the same orientation, while adjacent quarters of the screen 520 use the patterned fusible material in orientations rotated 90 degrees. Thus, in a first quarter 524 of the screen 520, the straight, parallel, linear elements 522 extend in a first direction, while in a second quarter 526, adjacent to the first quarter 524, the straight, parallel, linear elements extend in a second direction orthogonal to the first direction. In a third quarter 528 of the screen 520, opposite from the first quarter 524 and adjacent to the second quarter 526, the straight, parallel, linear elements extend in the first direction. The effect is a pattern of straight, parallel, oblique linear elements of fusible material generally depicting or suggesting lines extending toward a central area of the screen 520. FIG. 5C is a plan view of a solids separation screen 540 that uses the pattern of the screen 500 of FIG. 5A in another way. As in FIG. 5B, each quarter of the screen 540 has the pattern of straight, parallel, oblique linear elements, with opposite quarters using the same orientation and adjacent quarters using the pattern in an orientation rotated 90 degrees. In the screen 540, however, the pattern is arranged to depict diamond shapes converging toward the central area of the screen 540. The two screens 520 and 540 have sectioned patterns of fusible material, the sections being defined by the quarters of the screen having differentiated patterns of fusible material. The sectioned pattern of the two screens 520 and 540 will have different effects on movement of solids across the two screens, with the screen 520 tending to move larger solids preferentially toward the center of the screen, or hold larger solids longer near the center of the screen, while the screen 540 will tend to move larger solids toward the edges of the screen.

FIG. 6 is a plan view of a portion of a solids separation screen 600, according to another embodiment. This portion of the screen 600 has a patterned fusible material 602 arranged as two stripes forming a right-angle corner. The various patterns described above can be combined in any desired way to provide directional movement of solids that cross the screen across the entire areal extent of the screen or only at selected locations of the screen. Different patterns can even be applied to different sections of the screen to provide different solids movement directions.

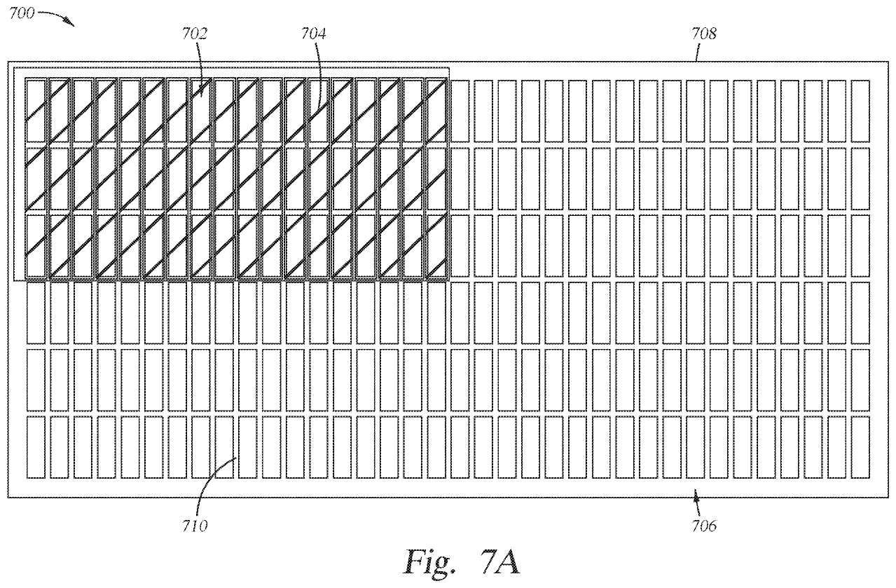

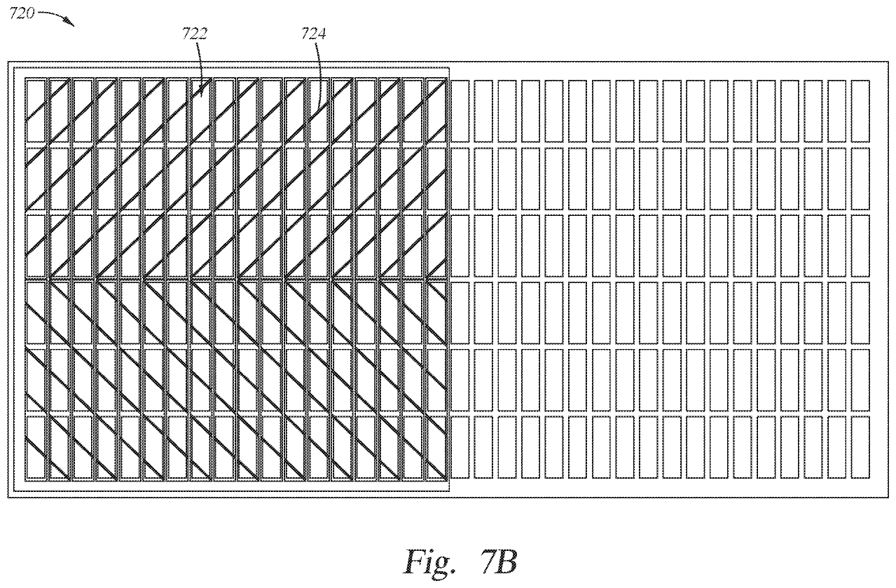

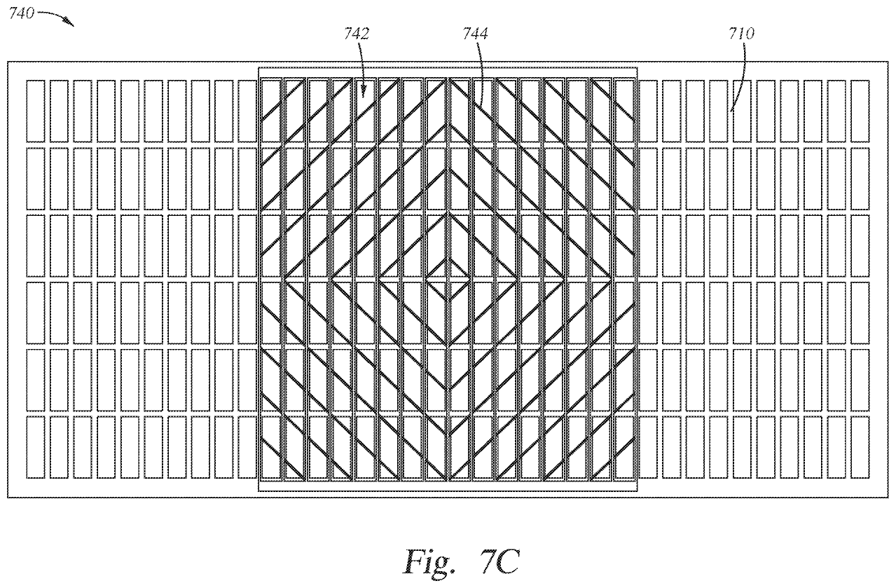

FIG. 7A is a plan view of a solids separation screen 700 according to another embodiment. The solids separation screen 700 illustrates how a patterned fusible material can be used in a portion of a solids separation screen, while no patterned fusible material is used in other portions of the same screen. Here, one-quarter of the screen 700 has a patterned fusible material 702. The patterned fusible material 702 has a plurality of stripes, ribs, or lines 704 arranged in a straight, parallel, oblique pattern of linear segments. The screen 700 has a frame 706 with an edge 708 and support members 710 that form a rectilinear pattern. The linear elements of the patterned fusible material 702 cross the support members 710 at angles determined by the pitch of the linear elements. The linear elements of the patterned fusible material 702 can be oriented to have any desired angle with respect to the support member 710. Here, the straight, parallel pattern of linear elements provides a regular pattern, but in other cases the angles of the linear elements could be varied to provide an irregular pattern. In still other cases, sections of the patterned fusible material 702 could have linear elements arranged in straight, parallel patterns at different angles, where a first section has a first angle and a second section has a second angle different from the first angle. Such an embodiment would have a pattern that is linear and angled, and also sectioned. In general, a pattern of fusible material used for one screen can be linear, angled, curved, sectioned, tessellated, or any combination thereof.

FIG. 7B is a plan view of a solids separation screen 720 according to another embodiment. The solids separation screen 720 has a patterned fusible material 722 disposed over half the areal extent of the screen 720, from edge to center and side to side of the screen 720. The patterned fusible material 722 of the screen 720 is linear, angled, and sectioned, with two quarters of the screen 720 having a pattern of straight, parallel, oblique stripes, ribs, or lines 724 of fusible material, with the pattern in each quarter rotated 90 degrees with respect to the pattern of the other quarter. The pattern of FIG. 7B is essentially the same as the pattern of FIG. 5C, but only on half the screen, in this case the “left half” of the screen.

FIG. 7C is a plan view of a solids separation screen 740 according to another embodiment. The solids separation screen 740 has a patterned fusible material 742 disposed over half the areal extent of the screen 740, like the screen 720 of FIG. 7B, but in this case the pattern is centered at the center of the screen 740 and extends from side to side of the screen 740. Thus, one-quarter of the screen 740, at each end thereof, has no patterned fusible material. This pattern is also linear, angled, and sectioned, with four sections of linear patterned fusible material. Each section has a pattern of straight, parallel, oblique stripes, ribs, or lines 744 oriented at angles to the support members 710 in a manner similar to the screen 540 of FIG. 5C resulting in diamond shapes appearing centered in the screen 740.

The preceding sections generally depict solids separation screens where the primary separation layer of the screen comprises two wire mesh structures with a fusible material encapsulating portions of the wire mesh structures in a patterned way, the fusible material being generally oriented in a linear pattern that may also be angled and/or sectioned. It should be noted that, where the patterned fusible material is sectioned, the sections can be joined by patterned fusible material, or separated, one from the other. The sections can also be formed using the same material, or a different material, using the same pattern element (stripe, bead, line, rib, etc.) or different pattern element, and can have the same or different dimensions, and the same or different spacing of pattern elements. Thus, a first section of the patterned fusible material can be made of a first polymeric material while a second section of the patterned fusible material can be made of a second polymeric material different from the first polymeric material. A first section of the patterned fusible material can be made of a first pattern element having a first shape and a first dimension while a second section is made of a second pattern element having a second shape and a second dimension, where the second shape is different from the first shape and/or the second dimension is different from the first dimension. A first section of the patterned fusible material can have pattern elements with a first spacing while a second section of the patterned fusible material can have pattern elements with a second spacing different from the first spacing.

The spacing of pattern elements, such as lines or curves, is generally selected to provide structural support for the fine mesh components of the primary separation layer (i.e. the wire mesh structures 102 and 104). Denser spacing, with more pattern elements in a given area, generally provides more structural support but allows less fluid throughput. In some embodiments of solids separation screens herein, spacing of pattern elements is selected to reduce fluid throughput no more than about 5% compared to a solids separation screen having no patterned fusible material encapsulating wire mesh structures of the screen.

Other embodiments to be described below show patterns having curves and potentially displaying information. The patterned fusible material, in these screens, generally encapsulates portions of the wire mesh structures having small mesh size (smaller than the third larger mesh size of the third wire mesh portion) in a first areal extent, and the primary separation layer formed by the wire mesh structures and the patterned fusible material has a second areal extent. In the embodiments described herein, a ratio of the first areal extent to the second areal extent is between about 0.01 and about 0.1. That is to say, the patterned fusible material extends over between about 1% and about 10% of the areal extent of the screen. The encapsulated portions of the screens may allow less liquid and solids to pass through those portions, without occluding flow through those portions. Increasing areal coverage of the patterned fusible material beyond 10% can thus reduce separation performance and/or throughput of the screens, while reducing areal coverage of the patterned fusible material below 1% can result in insufficient support and cushioning of the primary separation layer from contact with the third wire mesh structure.

It should be noted that width and thickness of stripes, lines, or ribs of patterned fusible material in the linear examples described above can be varied within one screen. Thus, a solids separation screen can have a primary separation layer comprising a first wire mesh structure, a second wire mesh structure, and a patterned fusible material encapsulating portions of the first wire mesh structure and the second wire mesh structure, where the patterned fusible material is implemented as a plurality of stripes, lines, or ribs as linear elements having varying width. A first portion of the linear elements can have a first width, while a second portion of the linear elements can have a second width different from the first width. Likewise, a first portion of the linear elements can have a first thickness, while a second portion of the linear elements has a second thickness different from the first thickness. The varying widths and/or thicknesses can, themselves, be arranged in a pattern to provide a certain solids flow orientation or direction across the screen. The varying widths and/or thicknesses can be combined with varying angles and varying sectional arrangements, as described above, to provide more flexibility in influencing flow across the screen.

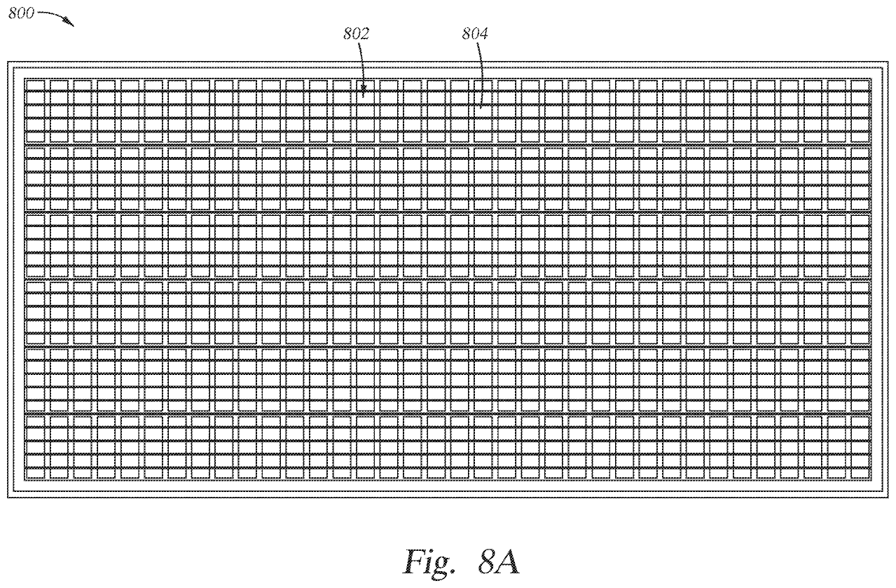

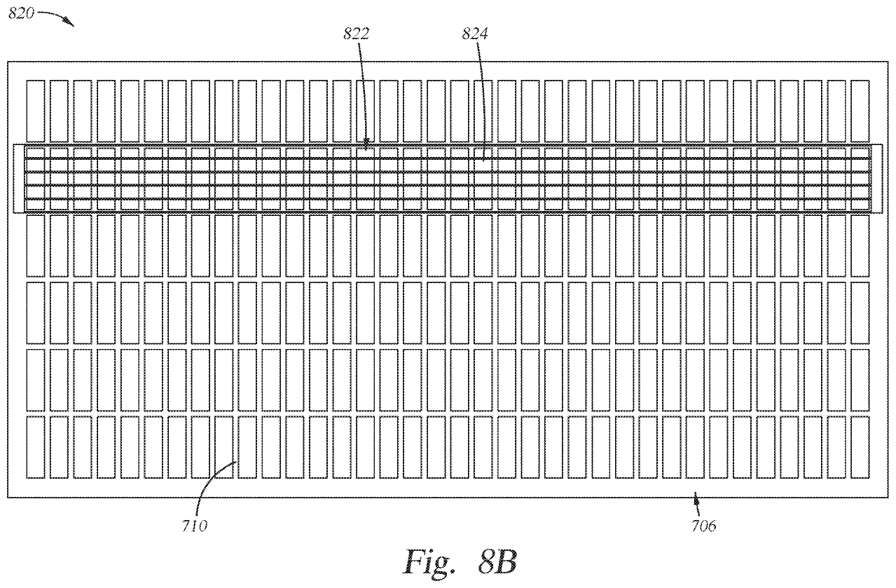

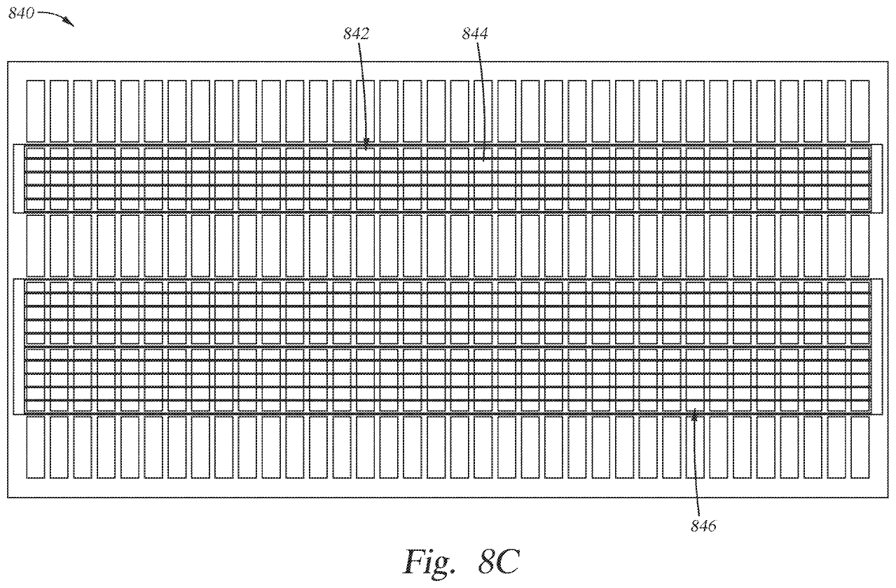

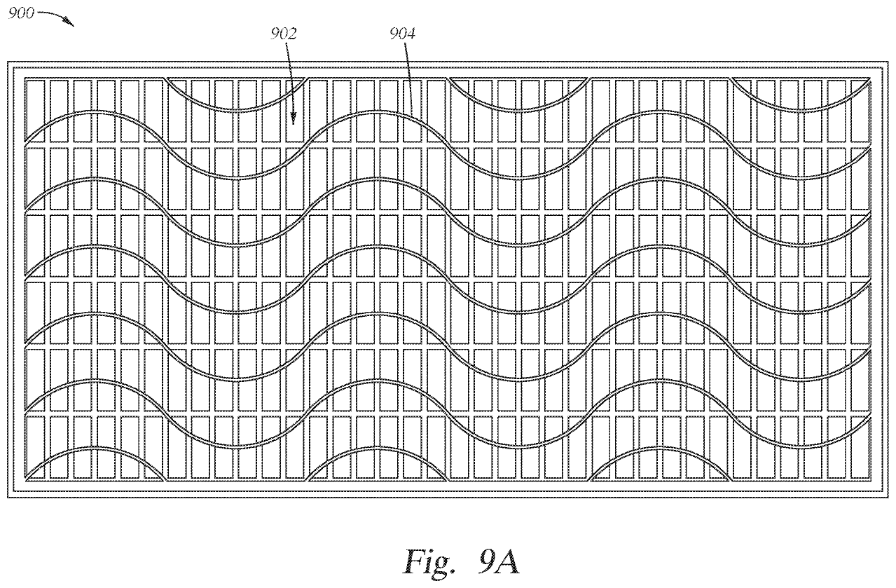

FIG. 8A is a plan view of a solids separation screen 800 according to another embodiment. The screen 800 uses a patterned fusible material 802 substantially as described above in the other embodiments herein. In the screen 800, however, the patterned fusible material is configured as a plurality of parallel stripes, ribs, or lines as linear elements 804 of uniform width and spacing extending across the areal extent of the screen 800 and parallel to a portion of the support members 710 of the frame 706. In this case, the linear elements 804 of the fusible material extend in the longitudinal direction of the screen 800, but another version could use linear elements of fusible material extending in the transverse direction of the screen. The patterned fusible material of the screen 800 is thus linear and regular, but is not angled or oblique, and is not sectioned or varying in width or spacing of the linear elements of fusible material.

FIG. 8B is a plan view of a solids separation screen 820 according to another embodiment. The screen 820 uses a patterned fusible material 822 that is linear, regular, and parallel, and not angled or oblique. This pattern, however, does not extend across the entire areal extent of the screen 820. In this case, parallel stripes, ribs, or lines, as linear elements 824 of fusible material, having uniform spacing and width extend in the longitudinal direction of the screen 820 in one section thereof, parallel to a portion of the support members 710 of the frame 706. FIG. 8C is a plan view of a solids separation screen 840 according to another embodiment. In this embodiment, parallel stripes, ribs, or lines, as linear elements 844, of fusible material having uniform spacing and width are arranged in sections, all the linear elements extending in the longitudinal direction of the screen 840. A first section 842 has a first plurality of linear elements 844 extending in the longitudinal direction of the screen 840, and a second section 846, spaced apart from the first section 842, has a second plurality of linear elements 844 extending in the longitudinal direction of the screen 840. The second section 846 has more linear elements, in this case, than the first section 842, but the two sections could have the same number of linear elements. The patterned fusible material of the screen 840 is therefore linear, regular, and sectioned, but is not angled or oblique.

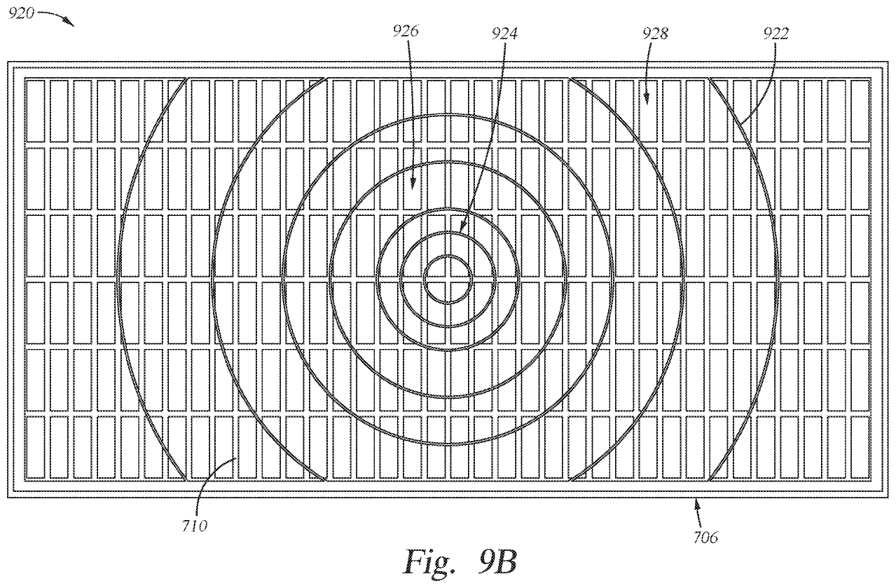

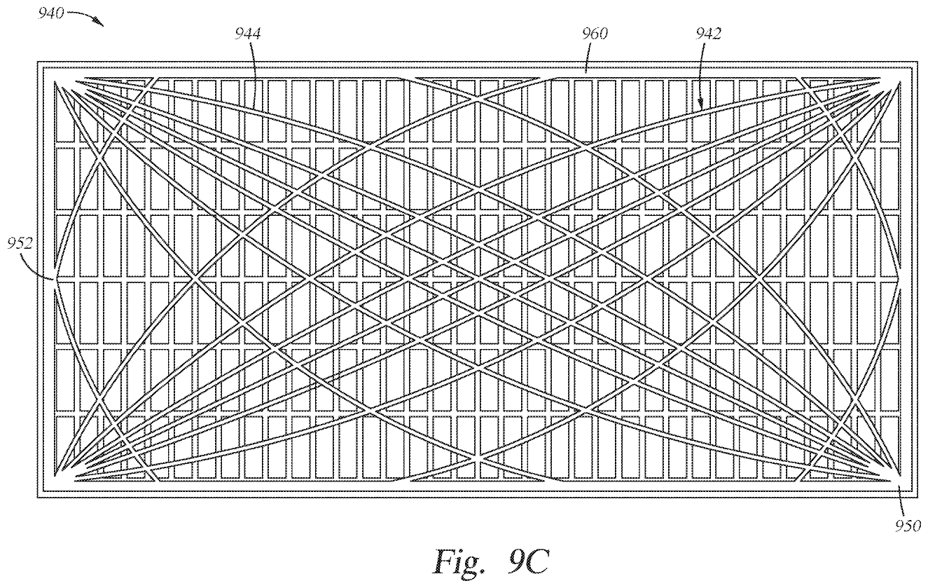

The patterned fusible material can be disposed in a screen in patterns having curves. FIG. 9A is a plan view of a solids separation screen 900 according to another embodiment. The screen 900 has a primary separation layer comprising a first wire mesh structure, a second wire mesh structure, and a patterned fusible material 902 encapsulating a portion of the first wire mesh structure and the second wire mesh structure in a curved pattern, which in this case is a pattern of wavy striped, ribs, or lines as curved elements 904, in this case wavy elements. This pattern is a regular, curved pattern with identical repeated wave shapes of uniform periodicity extending generally in the longitudinal direction of the screen 900, with uniform spacing in the transverse direction of the screen 900. The spacing of the wavy elements 904 is, in this case, approximately equal to the peak-to-trough amplitude of the wavy pattern, but the spacing of the wavy elements 904 could be less or more than shown in FIG. 9A. If arranged such that solids flow in the transverse direction of the screen 900, the wavy element 904 can influence movement of solids away from the center of the screen 900.

FIG. 9B is a plan view of a solids separation screen 920 according to another embodiment. The patterned fusible material of the screen 920 is arranged in a circular pattern. Here, curved stripes, ribs, or lines 922 of fusible material are arranged in a series of circles and arcs as circular elements generally concentric with the screen 920. Each of the circular elements 922 has a radius that is equal to a distance of an integer number of support members 710 in the longitudinal direction of the screen 920. In this case, the circular elements are also generally spaced apart with increasing space further from the center of the screen 920. The spacing of the circular elements is also in sections, so the pattern of the screen 920 is sectioned. In a first section 924, near a center of the screen 920, spacing between adjacent circular elements 922 is equal to the distance between two adjacent support members 710 of the frame 706 in the longitudinal direction of the screen 920. In a second section 926, spacing between adjacent circular elements 922 is equal to the distance, in the longitudinal direction of the screen 920, covered by three support members 710. In a third section 928, spacing between adjacent circular elements 922 is equal to the distance, in the longitudinal direction of the screen 920, covered by four support members 710. The second section 926 is between the first section 924 and the third section 928. Where the radius of the circular elements 922 exceeds a dimension of the screen 920, the circular elements 922 are truncated such that circular arcs of fusible material are provided at outer parts of the pattern.

The pattern of the screen 920 of FIG. 9B is thus curved, regular, and circular with variable spacing, increasing monotonically with distance from the center of the screen 920, of parallel, in this case concentric, stripes, ribs, or lines. Also, in this case, dimensions of the patterned fusible material are related to dimensions of the frame 706, specifically of the support members 710. Spacing of the circular elements 922 of the patterned fusible material is an integer multiple of the spacing between support members 710 in the longitudinal direction of the screen 920.

FIG. 9C is a plan view of a solids separation screen 940 according to another embodiment. In the screen 940, a patterned fusible material 942 is implemented as a series of arcuate stripes, ribs, or lines as arcuate elements 944, each having center of curvature that is not within the areal extent of the screen 940. Each arcuate element 944 generally intersects at least one other arcuate element 944 to form an angle. Most of the arcuate elements 944 intersect with corners 950 of a primary separation layer 960 of the screen 940 defined by the first wire mesh structure, second wire mesh structure, and patterned fusible material 942, and a portion of the arcuate elements intersect with edges 952 of the primary separation layer 960. The pattern of the fusible material in the screen 940 is regular, curved, and angled, with variable spacing.

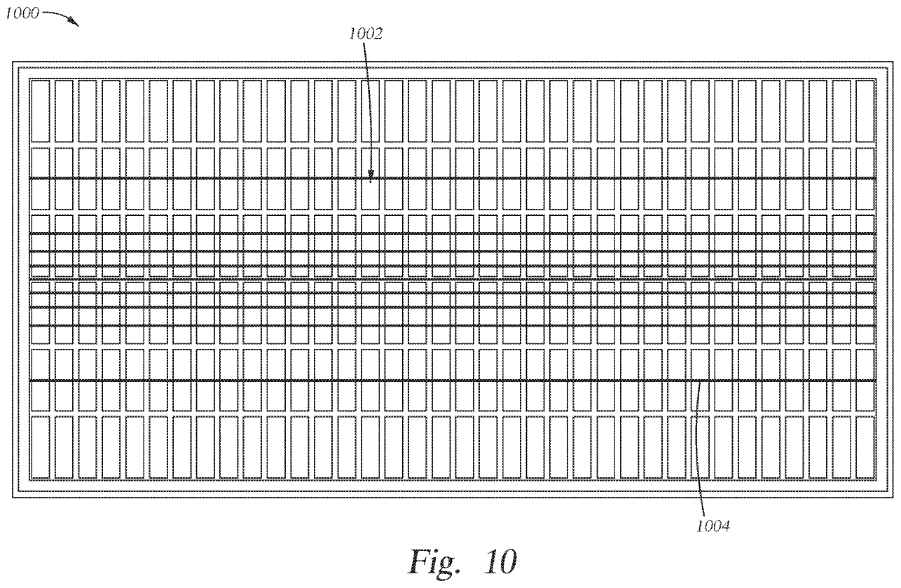

FIG. 10 is a plan view of a solids separation screen 1000 according to another embodiment. The solids separation screen 1000 has a linear pattern of fusible material 1002 encapsulating portions of the first and second wire mesh structures, with straight, parallel stripes, ribs, or lines as linear elements 1004 of fusible material arranged with graduated spacing that increases with distance from a center of the screen 1000. This graduated spacing may be sectioned, with different sections of the screen having different spacings, or the graduated spacing may be quasi-continuous, with each parallel linear element spaced further from its next neighbor away from the center of the screen than from its next neighbor toward the center of the screen. The parallel linear elements, in this case, extend in the longitudinal direction of the screen forming a regular, linear pattern.

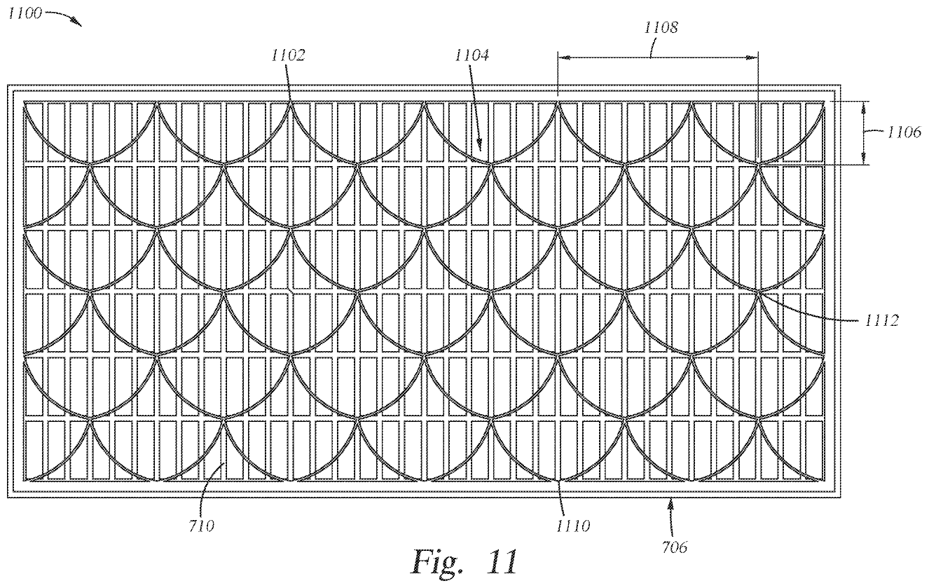

FIG. 11 is a plan view of a solids separation screen 1100 according to another embodiment. The solids separation screen 1100 has a curved pattern of fusible material 1102 encapsulating portions of the first and second wire mesh structures in a regular, repeating pattern of constant periodicity. The pattern consists of a plurality of scale shapes 1104 (like the scales of a fish) distributed in rows 1106 along the longitudinal direction of the screen 1100, and distributed in staggered columns 1108 along the transverse direction of the screen 1100. The scale shapes 1104 in the columns 1108 are staggered with half-pitch, each scale 1104 being staggered by half its width with respect to neighboring scales 1104 in adjacent rows 1106. The pattern of the screen 1100 is tessellated in a regular, repetitious manner, with scale-shaped elements. It should be noted that a screen can be tessellated in this way using any suitable shape, which can be curved or angular. It should also be noted that the size, shape, and spacing of scale shapes can be varied. In this case, each scale 1104 extends, in the transverse direction of the screen 1100, to an apex 1110 and each scale 1104 intersects two scales of a neighboring row 1106 of scales 1104 at a point of intersection 1112 where an apex 1110 of one scale 1104 intersects two neighboring scales 1104. Thus, in this scale pattern, three scales intersect at each internal intersection point of the pattern and two scales intersect at each edge intersection point of the pattern. It should also be noted that the scales in this case have sizes that are related to the spacing of support members 710 of the frame 706 in two orthogonal directions.

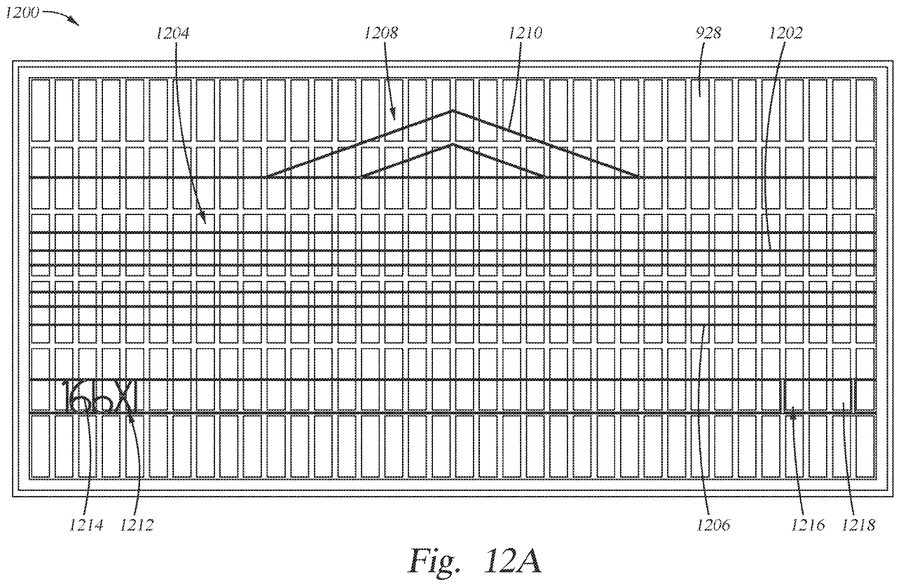

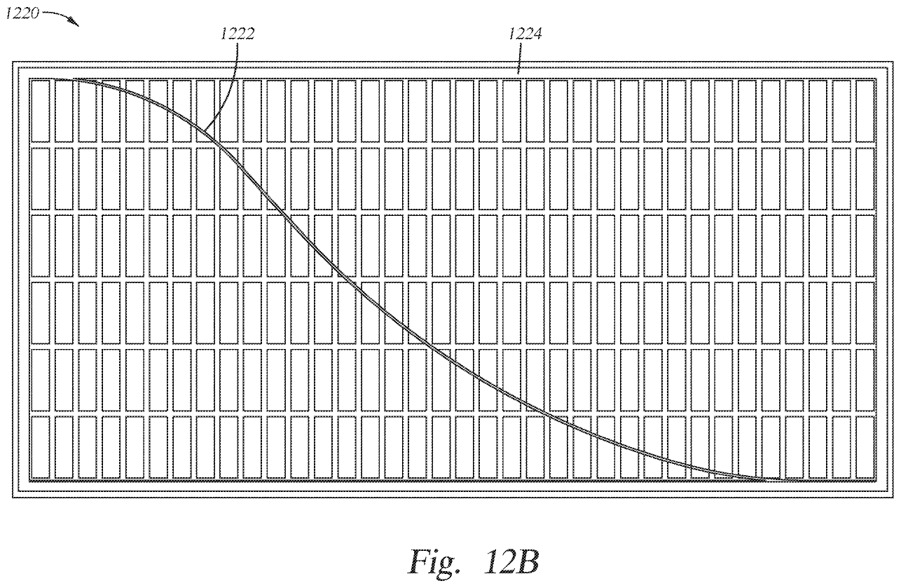

The pattern of the fusible material used to encapsulate portions of the first and second wire mesh structures can convey information, which can be graphical or even written. FIG. 12A is a plan view of a solids separation screen 1200 according to another embodiment. The solids separation screen 1200 has an irregular pattern of fusible material 1202 encapsulating portions of the first and second wire mesh structures to convey information. The pattern of the screen 1200 is also sectioned, where a first section 1204 has a regular, linear, parallel pattern 1206 of fusible material, a second section 1208 has a regular linear, angled pattern 1210 of fusible material expressing a first information, a third section 1212 has an irregular pattern 1214 of fusible material expressing a second information, and a fourth section 1216 has an irregular pattern 1218 of fusible material expressing a third information. In this case, the first information of the second section 1208 is a graphic, the second information of the third section 1212 is a writing, and the third information of the fourth section 1216 is a graphic. Here, the first information is a directional instruction, the second information is a model number, and the third information is a generic shape. In some cases, however, the third information could be a logo. The linear, parallel pattern 1206 of the first section 1204 is like the graduated pattern of the screen 1000 of FIG. 10. The second, third, and fourth sections 1208, 1212, and 1216 are located at peripheral parts of the screen, but could be anywhere within the areal extent of the screen, depending on any function contemplated for the irregular patterns.

FIG. 12B is a plan view of a solids separation screen 1220 according to another embodiment. The screen 1220 has a single continuously curved stripe, rib, or line 1222 as a curved element of fusible material encapsulating portions of the first and second wire mesh structure. The curved element 1222 of the screen 1220 has a generally sigmoidal shape and intersects with opposite corners of a primary separation layer 1224 defined by the first and second wire mesh structures and the fusible material of the curved element 1222. Here, only one such sigmoidal line is shown, but in other embodiments any number of such lines can be used, which can be parallel or intersecting in any desired manner.

Solids separation screens are presented herein that feature three wire mesh structures attached to a frame. A first wire mesh structure having a first mesh size, a second wire mesh structure having a second mesh size, and a third wire mesh structure having a third mesh size are all attached to a frame. The third mesh size is larger than the second mesh size, and portions of the first and second wire mesh structures are encapsulated by a patterned fusible material to form a primary separation layer of the screen. The fusible material generally provides extra support for the first and second wire mesh structures, lending additional strength to the structure. The fusible material also provides a cushion against contact between the third wire mesh structure and the primary separation layer to prevent unwanted wear to either structure. Such patterned fusible materials can be used with screens that have two or more than three, for example four, wire mesh structure layers. Where more than three wire mesh structure layers are used, more than two wire mesh layers can be encapsulated using a patterned fusible material. Where only two wire mesh structure layers are used, only one of the wire mesh structures might be encapsulated using a patterned fusible material as described herein, or both wire mesh structures might be so encapsulated. In some cases where a solids separation screen comprises three or more wire mesh layers, the patterned fusible material can encapsulate only one of the wire mesh layers, or more than one of the wire mesh layers.

A solids separation screen according to the description herein can also have one wire mesh structure that is partially encapsulated by a patterned fusible material to form a primary separation layer of the screen. The primary separation layer thus formed can be coupled to a frame like the structures shown in FIGS. 4-12B. Such a primary separation layer can be formed by placing the patterned fusible material in contact with the wire mesh structure and applying heat and pressure, as described above, to fuse the wire mesh structure with the patterned fusible material.

The pattern of the fusible material can be linear, curved, angled, tessellated, and sectioned in any manner or combination, and can be applied as stripes, ribs, lines, sheets, or portions thereof, in any manner or combination. The pattern of the fusible material can be regular or irregular, periodic or random, graduated, variable, or constant in any respect, can have areal extent over all or part of the screen, and can convey information. The pattern of the fusible material can also influence material flow across and/or through the screen and can be selected or optimized for use in different environments. In the general context of producing subterranean resources, the pattern could be optimized for separating solids of different composition. For example, a first screen could be optimized for separating a first solids type, for example sandstone, and a second screen could be optimized for separation a second solids type, for example shale. The same base screen (i.e. the third wire mesh structure 106) could be used with different primary separation layers selected based on the materials to be separated.

The solids separation screens described herein generally have two wire mesh structures supported by a patterned fusible material encapsulating portions of the two wire mesh structures. It should be noted that the portions of the two wire mesh structures could be encapsulated by patterned fusible materials separately, and then joined together into a solids separation screen. For example, the first wire mesh structure 102 could be treated using a first patterned fusible material to encapsulate portions of the first wire mesh structure 102, and separately the second wire mesh structure 104 could be treated using a second patterned fusible material to encapsulate portions of the second wire mesh structure 104. The two wire mesh structure 102 and 104, having been separately treated using patterned fusible material, can then be joined with the third wire mesh structure 106 by attaching all three to the frame to form a solids separation screen. In such embodiments, a first screen can be formed from the first wire mesh structure, as a single wire mesh structure, treated with the first patterned fusible material. Likewise, a second screen can be formed from the second wire mesh structure, as a single wire mesh structure, treated with the second patterned fusible material. In such embodiments, the treatments applied to the first and second wire mesh structures 102 and 104 can be the same or different in any respect. For example, a different fusible material can be used for the two wire mesh structures, or a different collection of fusible materials. A different pattern can be applied to the two wire mesh structures, with different shapes, dimensions, thicknesses, curves, angles, sections, etc.

It should also be noted that where two wire mesh structures like the wire mesh structures 102 and 104 are treated to different patterned fusible materials, the resulting separate screens can also be further treated, together, using a third patterned fusible material. In such cases, two wire mesh structures will each have a patterned fusible material separately encapsulating a portion of each wire mesh structure, for example a first patterned fusible material encapsulating a portion of the first wire mesh structure and a second patterned fusible material encapsulating a portion of the second wire mesh structure. The two wire mesh structures thus separately encapsulated can also have a third patterned fusible material encapsulating portions of both the first wire mesh structure 102 and the second wire mesh structure 104.

The preceding description has been presented with reference to present embodiments. Persons skilled in the art and technology to which this disclosure pertains will appreciate that alterations and changes in the described structures and methods of operation can be practiced without meaningfully departing from the principle, and scope of this present disclosure. Accordingly, the foregoing description should not be read as pertaining only to the precise structures described and shown in the accompanying drawings, but rather should be read as consistent with and as support for the following claims, which are to have their fullest and fairest scope.

1. A solids separation screen comprising:
a primary separation layer comprising:
a wire mesh structure; and,
a patterned fusible structure having a linear, angled, or curved pattern, or combination of such patterns, the patterned fusible structure comprising a polymer material encapsulating a portion of the wire mesh structure.

2. The solids separation screen of claim 1, wherein the wire mesh structure comprises a first mesh layer having a first mesh size, a second mesh layer having a second mesh size, and a third mesh layer having a third mesh size, the third mesh size larger than the first mesh size and the second mesh size, wherein the patterned fusible structure encapsulates at least a portion of the first mesh layer and the second mesh layer.

3. The solids separation screen of claim 1, wherein the linear, angled, or curved pattern is a plurality of linear segments crossing each other at 90 degree angles.

4. The solids separation screen of claim 1, wherein the linear, angled, or curved pattern expresses information.

5. The solids separation screen of claim 1, wherein the patterned fusible structure extends across the entire areal extent of the primary separation layer.

6. The solids separation screen of claim 1, wherein the patterned fusible structure is made of a material that softens at a first temperature below a second temperature at which the wire mesh structure is affected.

7. The solids separation screen of claim 6, wherein the wire mesh structure is metal.

8. The solids separation screen of claim 1, wherein the patterned fusible structure comprises a plurality of parallel stripes spaced apart with a variable spacing.

9. A method of making a solids separation screen, comprising:
obtaining a first wire mesh structure having a first mesh size, a second wire mesh structure having a second mesh size, and a third wire mesh structure having a third mesh size, the third mesh size larger than the first mesh size and the second mesh size;
disposing a patterned fusible structure having a linear, angled, or curved pattern, or combination of such patterns, against the first and second wire mesh structures;
applying heat and pressure to the first wire mesh structure, the second wire mesh structure, and the patterned fusible material to heat the first wire mesh structure, the second wire mesh structure, and the patterned fusible structure to a first temperature below a second temperature at which the first wire mesh structure and the second wire mesh structure are affected;
encapsulating at least a portion of the first wire mesh structure and the second wire mesh structure with the patterned fusible structure to form a supported wire mesh structure; and
attaching the supported wire mesh structure and the third wire mesh structure to a frame.

10. The method of claim 9, wherein each of the first wire mesh structure, the second wire mesh structure, and the third wire mesh structure is metal.

11. The method of claim 9, wherein disposing the patterned fusible structure against the first and second wire mesh structures comprises disposing the patterned fusible structure between the first and second wire mesh structures.

12. The method of claim 9, wherein the patterned fusible structure comprises a rectilinear pattern of stripes made of a polymeric material.

13. The method of claim 9, wherein the patterned fusible structure expresses information.

14. The method of claim 9, wherein the patterned fusible structure comprises a plurality of parallel stripes spaced apart with a variable spacing.

15. The method of claim 9, wherein the patterned fusible structure extends across the entire areal extent of the first and second wire mesh structures.

16. A solids separation screen, comprising:
a frame;
a primary separation layer attached to the frame, the primary separation layer comprising:
a first metal wire mesh structure;
a second metal wire mesh structure; and
a patterned fusible structure encapsulating a portion of the first wire mesh structure, the second wire mesh structure, or both; and
a third metal wire mesh structure attached to the frame.

17. The solids separation screen of claim 16, wherein the first metal wire mesh structure has a first mesh size, the second metal wire mesh structure has a second mesh size, the third metal wire mesh structure has a third mesh size, the third mesh size is larger than the first mesh size and the second mesh size, and the patterned fusible structure comprises strips of a polymeric material that softens at a first temperature below a second temperature at which the first metal wire mesh structure, the second metal wire mesh structure, or the third metal wire mesh structure is affected.

18. The solids separation screen of claim 16, wherein the patterned fusible structure has a regular linear, angular, or curved pattern, or a combination of such patterns.

19. The solids separation screen of claim 16, wherein the encapsulated portion of the first metal wire mesh structure, the second metal wire mesh structure, or both has a first areal extent, the primary separation layer has a second areal extent, and a ratio of the first areal extent to the second areal extent is between about 0.01 and 0.1.

20. The solids separation screen of claim 16, wherein the frame has a first rectilinear structure, the patterned fusible structure has a second rectilinear structure, and the first rectilinear structure is angled with respect to the second rectilinear structure.

21. The solids separation screen of claim 1, wherein the wire mesh structure comprises a first mesh layer and a second mesh layer, and wherein the patterned fusible structure encapsulates a portion of only the first mesh layer.
